(19) United States
(12) Patent Application Publication
(10) Pub. No.: US 2023/0031508 A1
(43) Pub. Date: Feb. 2, 2023

(54) MODULAR TUBE APPARATUS

(71) Applicant: STANLEY BLACK & DECKER, INC., New Britain, CT (US)

(72) Inventor: Rodrigo S. DELGADO, Milford, MA (US)

(21) Appl. No.: 17/390,886

(22) Filed: Jul. 31, 2021

(51) Int. Cl. A47B 96/14; B25H 1/16

(52) U.S. Cl. CPC A47B 96/1433; B25H 1/16; A47B 96/1458

(57) ABSTRACT

A modular tube apparatus that can include metal legs as an inner part of an overall height adjustable leg of a workstation. Each leg piece can include a plurality of protrusions on each side to help align parts for assembly and vertical shear strength. There are also notches on each side to self-align holes on the two parts and for additional shoulder support. The overall adjustable legs may include a base plate for securement and an outer tube leg to provide additional strength and securement.

### FIELD

This document relates, generally to storage and, in particular to a plurality of height adjustable workstations.

### BACKGROUND

Workbenches are well known in the tool and trade industry. Example of a workbench are typically workbenches used by craftsman and tradesmen. Those workbenches are generally static and have a set or defined height level. However, when professional builders, carpenters, tradesman, and craftsmen need support or ability to work at different h levels, such as for different sized items, often other items are added to the surface of the workbench to increase the height of the working space. Alternately, there is generally no adjustment to decrease or lower the height level of the work bench.

In order to meet the needs of different users on the desktop height, commonly used reading tables, computer tables or office desks, are normally equipped with an elevation adjustment mechanism for allowing users to adjust the height of table legs as desired. Referring to a conventional table leg, it generally comprises a fixed outer tube and a movable inner tube movably inserted in the fixed outer tube. By means of adjusting the elevation of the movable inner tube relative to the fixed outer tube, the height of the table leg is thus adjusted. However, the movable inner tube will be rubbed against the fixed outer tube, causing wear and noise problems. Thus, this related art design still has room for improvement.

The extendable leg designs which are widely use currently consisting of two (inner and outer) extruded squared, round or sometimes rectangular tubes. The extendable legs are assembled onto table-tops or work bench tops which allows the Users the ability to adjust the top's height. Most table, bench manufacturers purchase these extrusions from outside suppliers, but the outer dimensions of inner tube and inner dimension of outer tube don't always align which creates gaps between tube's walls that either requires shimming or cause sloppiness in fit. The alternative to purchasing extruded tubes would be forming bar stocks into two C-shaped half and then weld both together to form a squared leg. However, welding takes time and secondary grinding, sanding to provide flat surface. Thus, there still exists a need for an innovative design that eliminates the need to purchase outside extruded tubes, eliminates the need for welding, or saves tremendous amount of time in manufacturing

### SUMMARY

An object of the present invention is to solve the problem with ordinary workstations that are limited to a certain height level.

Another object of the present invention is to provide a workstation having parts that reduce wear and tear of typical height adjustable workstations

Another object of the present invention is to provide a workstation that are aligned and removes gaps and other improper part fittings that can lead to structural defects.

In accordance with one aspect of the present invention, the invention is a modular tube apparatus comprising a fixed outer tube, an inner leg movably inserted in the fixed outer tube, wherein the inner leg includes a protruding member and a recessed member adapted to securely stopped against an inner surface of the fixed outer tube, and a base plate, wherein the base plate is perpendicular to the inner leg and adapted to secure the inner leg from unelected movement wherein the fixed outer tube and inner leg includes a plurality of apertures configured to affix both the outer tube and inner leg together, and wherein the outer tube is movable relative to the inner leg to achieve a desired height level

The terminology used herein is for the purpose of describing implementations or embodiments only and is not intended to be limiting of the invention. As used herein, the singular forms, “a”, “an” and “the” are intended to include the plural forms as well, unless the context clearly indicates otherwise. It will be further understood that the root terms “can”, “include”, “can include”, “may”, and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, system, or apparatus that comprises a list of features is not necessarily limited only to those features but may include other features not expressly listed or inherent to such process, method, article, system, or apparatus.

For definitional purposes and as used herein “connected” or “attached” includes operation or physical, whether direct or indirect, affixed or coupled, as for example an inner leg operatively coupled to the fixed our leg for providing electable height adjustment of a workstation. Thus, unless specified, “connected” or “attached” is intended to embrace any operationally functional connection.

As used herein “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to accompanying Figures and drawings which are provided for illustration purposes as representative of specific exemplary embodiments in which the invention may be practiced. Given the following description of the specification and drawings, the apparatus, system, and methods should become evident to a person of ordinary skill in the art. Further areas of applicability of the present teachings will become apparent from the description provided herein. It is to be understood that other embodiments can be utilized and that structural changes based on presently known structural and/or functional equivalents can be made without departing from the scope of the invention.

### BRIEF DESCRIPTION OF THE DRAWINGS

The above-mentioned and other features and advantages of this invention, and the manner of attaining them, will become more apparent and the invention will be better understood by reference to the following descriptions of embodiments of the invention taken in conjunction with the accompanying and drawings:

FIG. 1 illustrates a perspective, partially exploded view of a tube leg and a base plate assembly according to the present invention.

FIG. 2 illustrates a perspective view of the tube leg and base plate assembly of FIG. 1 according to the present invention.

FIG. 3 illustrates a close-up partial view of the tube leg and base plate assembly of FIG. 2.

FIG. 4A illustrates a perspective, partially exploded view of the tube leg and base plate assembly configured to couple to a wheeled base.

FIG. 4B illustrates a perspective, partially exploded view of the tube leg and base plate assembly coupled to the wheeled member.

FIG. 5 is a perspective view of the tube leg and base plate assembly coupled to the wheeled member.

FIG. 6 is a perspective, partial view of the tube leg and base plate assembly coupled to a wall of a workstation.

FIG. 7 is a perspective view of the tube leg and base plate assembly coupled to a wall of a workstation including partial support for a worktop.

Corresponding reference characters indicate corresponding parts throughout the several views. The exemplifications set out herein illustrate embodiments of the present invention, and such exemplifications are not to be construed as limiting the scope of the present invention in any manner.

### DETAILED DESCRIPTION

A detailed description of apparatuses, methods, and systems, consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Referring to the present invention, there are a plurality of figures and description of one embodiment of the modular tube apparatus. The Figures includes descriptions of the modular tube apparatus having a two piece design of tube legs, where each tube leg includes tab on each side for vertical shear strength and to align together removing gaps and incorrect fittings. There are also notches on each side to self-align holes on the two parts and for additional shoulder support. The overall adjustable legs may include a base plate for securement and an outer tube leg.

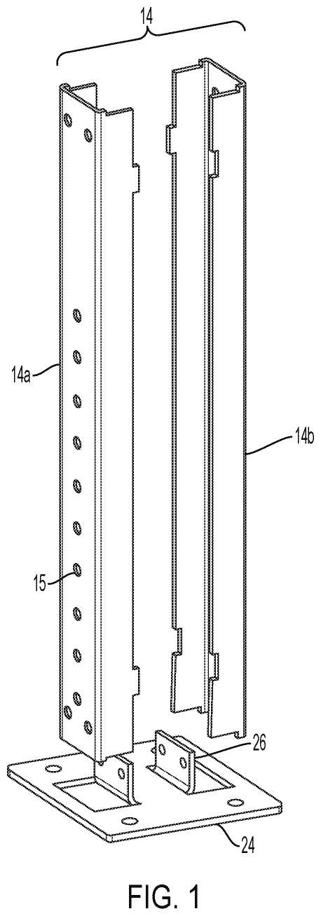

Referring to FIGS. 1-7, there are a plurality of figures of one embodiment of a modular tube apparatus 10. FIG. 1 illustrates a perspective view of the modular tube apparatus 10 according to the present invention. As represented in FIG. 1, the tube apparatus 10 includes a plurality of tube legs 14 and a base plate 24. The plurality of tube legs 14 can include apertures 15 in the wall of the legs. The tube 14 can include a plurality of brackets configured to couple together to form the tube leg 14. In one embodiment the plurality of tube legs 14 can also include a number of protruding members and recessed members that are configured to mesh together to form the tube leg 14. In this embodiment the protruding members of one tube leg, such as a male bracket, is adapted to operatively couple to the recessed member of a corresponding tube leg, such as a female bracket. The base plate 24 may be perpendicular to axis of the tube leg 14 and can include at least one protruding member 26 or tab configured to fit against a wall of a tube leg 14. The protruding tab 26 of the base plate 24 may be parallel to the tube legs 14 for securing the tube leg onto the base plate 14 The base plate can include an opening approximate the protruding tab 26 to receive at least part of the tube leg 14, such as leg 14 or leg 14b.

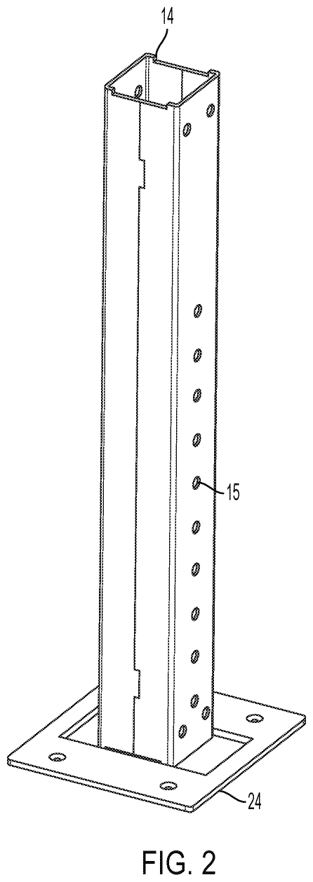

FIG. 2 illustrates the tube legs 14 coupled together and placed onto the base plate 24. The protruding members of the tube leg 14a is shown coupled to the recessed members of the corresponding tube leg 14b. The base plate 24 is shown perpendicular to the axis of the tube leg 14 and includes the protruding tab 26 (not shown) slotted to fit against the walls of the tube legs 14a, 14b. The tube legs 14a, 14b are also fitted into at least one opening 25 of the base plate configured to retain the bottom portion of the tube legs 14.

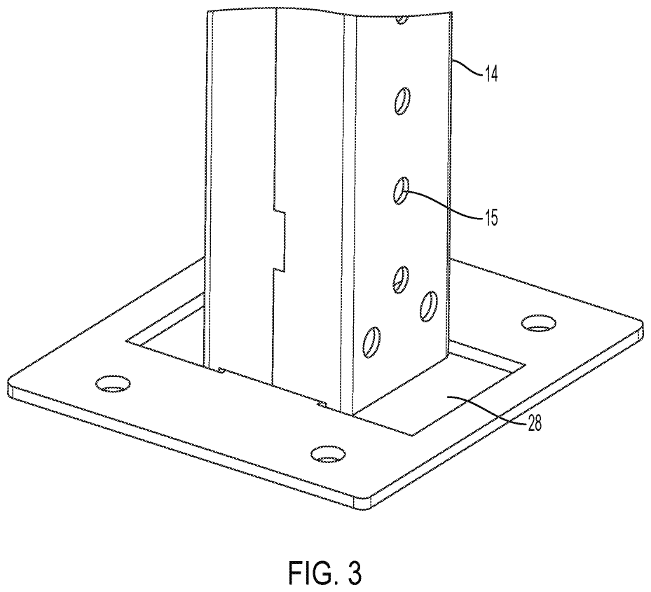

FIG. 3 shows a partial, close-up view of the tube legs 14a, 14b coupled together and placed onto the base plate 24. The tube legs 14a, 14b are fitted into the opening 25 of the base plate 24 that is configured to secure and retain the bottom portion of the tube legs 14. The protruding tabs 26 of the base plate 24 are secured against the fit against the walls of tube leg 14a, 14b to provide support of the tube leg in a vertical position. The protruding tabs 26 of the base plate 24 may also include apertures 15 that may retain bolts for securing the tube legs 14 to the base plate 24.

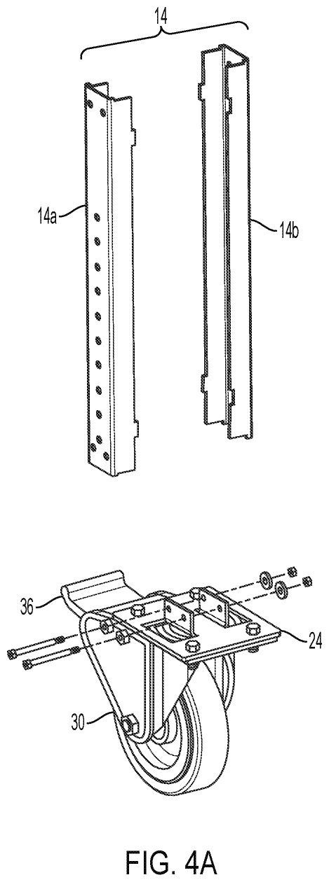

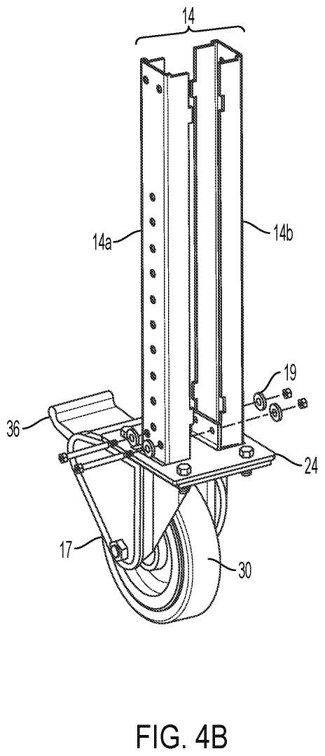

FIG. 4A illustrates a perspective, partially exploded view of the tube leg 14 and base plate 24 assembly configured to couple to a wheeled member 30. In FIG. 4A the tube legs 14a, 14b are shown uncoupled and not attached to the base plate 24. The wheeled member 30 is shown affixed to the base plate 24 to allow for horizontal movement of the modular tube apparatus 10. The wheeled member 30 may include a stopped member 36 that can be selectively actuated in order to allow or prevent movement of a moveable workstation. FIG. 4B illustrates a perspective, partially exploded view of the tube leg 14 and base plate 24 assembly coupled to the wheeled member 30. In FIG. 4B it is illustrated that the tube legs 14a, 14b are still in an up-coupled arrangement as shown in FIG. 4A but placed over at least one opening 25 of the base plate 24. In this FIG. 4B the bottom portion of the tube legs 14a, 14b are configured to be retained within the at least one opening 25 of the base plate 24 to provide support of the tube leg 14 in a vertical position. In this Figure, there is illustrated a plurality of bolts 17 and washers 19 aligned to fit in relation to the plurality of apertures 15 of the tube legs and the apertures 27 of the base plate 24.

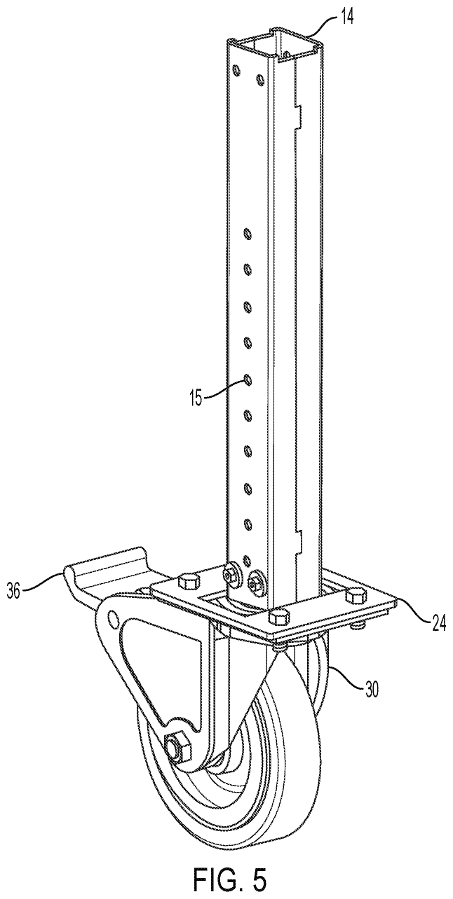

FIG. 5 depicts a perspective view of the tube leg 14 and base plate assembly 24 coupled to the wheeled member 30. In this Figure there is illustrated the plurality of bolts 17 and washers 19 are fitted into the relation to the plurality of apertures 15 of the tube legs 14 and the apertures 27 of the base plate 24. The bolts 17 and washers 19 are fastened into the tube legs 14 and the base plate 24 to provide securement of the tube legs 14 and support of the tube legs 14 in a vertical position. There are also illustrated a number of bolts fastened from the base plate 24 onto the wheeled member 30 to allow selective movement of a workstation 6. In this illustration the stoppable member 36 is engaged in a stopped mode to prevent unintended horizontal movement of the overall workstation 6 (not shown).

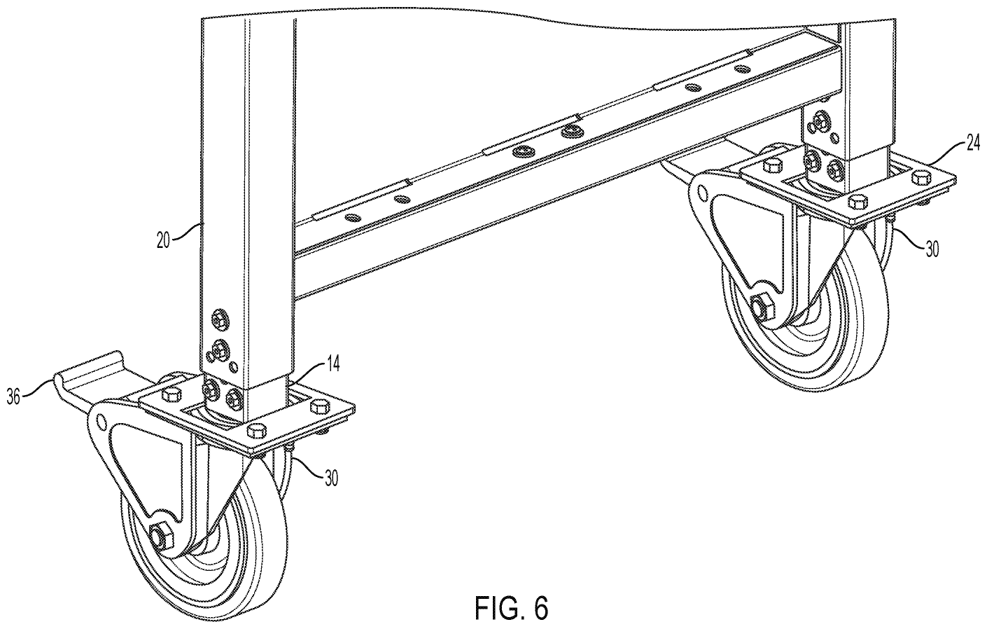

FIG. 6 is a perspective, partial view of the tube leg and base plate assembly coupled to a wall of a workstation 6. In this Figure, the plurality of bolts 17 and washers 19 are fitted into the relation to the plurality of apertures 15 of the tube legs 14, the apertures 27 and opening 25 of the base plate 24. The bolts 17 and washers 19 are fastened into the tube legs 14 and the base plate 24. There are also illustrated a number of bolts fastened onto the wheeled members 30 to allow selective movement of a workstation 6. The Figure illustrates two wheeled members 30, such as the wheeled member of FIG. 5, and there are two tube legs 14 that are partially contained within an outer tube 20.

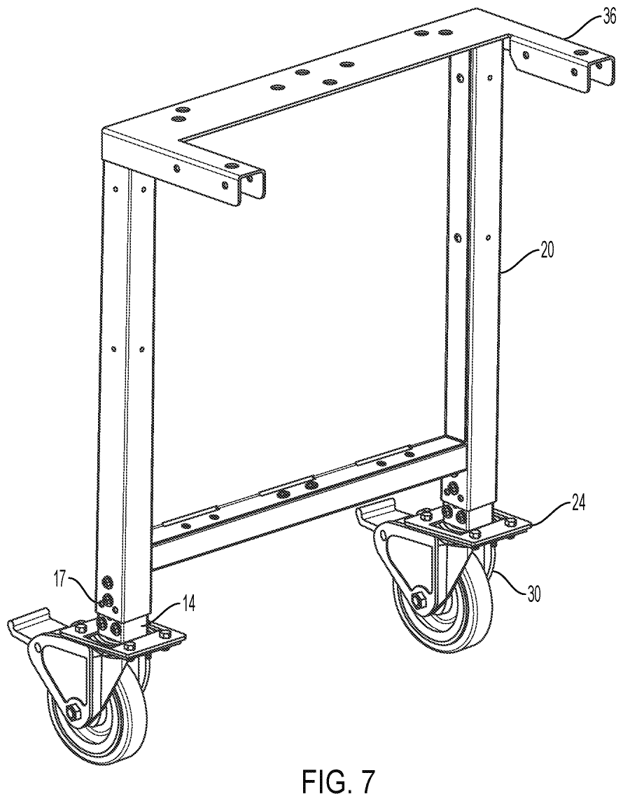

FIG. 7 is a perspective view of the modular tube apparatus 10 including the tube legs 14, base plate 24, and wheeled member 30 assembly coupled to a wall of a workstation 6 including partial support to surface rails 63 for a worktop. In this illustration the tube legs are partially contained within the outer tube 20. The outer tube 20 can be a hollow outer surface adapted to house the tube legs 14. Part of the outer tube 20, such as the upper portion of the outer tube 20, can be used to support surface rails 63 for a workstation 6.

The outer tube 20 can also include a plurality of apertures 21 in at least one wall of the outer tube 20 wherein bolts 17 and washers 19 can be fastened into any of the apertures 15 of the tube legs 14 to provide additional securement of the modular tube apparatus 10. In this Figure, the outer tube 20 is illustrated fastened onto the tube legs 14 with the bolts 17 at a bottom aperture 15 but can be fastened onto the tube legs 14 at any of the apertures 15, such as any of the apertures 15 in the tube leg 14 shown in FIG. 5. The bolts 17 can be selectively moved into another aperture 15 of the tube legs to adjust the height level of the overall workstation 6.

In various embodiments of the present invention, the modular tube apparatus 10 includes tube legs 14 having a plurality of apertures 15 but is not limited to this and may include other affixing surfaces for fastening to the tube leg 14 such as welding, clipping, bolting, screwing, slotted attachments, bracings, latching, adhesive, pins, protrusions, and indentations.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus, system and/or methods described herein may be combined in any combination, except mutually exclusive combinations. The implementations described can include various combinations and/or sub-combinations of the functions, components and/or features of the different implementations described.

We claim:

1. A modular tube apparatus comprising:
an outer tube;
at least one tube leg, the tube leg including a male bracket and female bracket configured to couple together to form the at least one tube leg, and wherein the at least one tube leg is movably inserted in the outer tube and adapted to securely stop against an inner surface of the outer tube; and
a base plate, wherein the base plate is perpendicular to the axis of the tube leg and adapted to secure the tube leg from unelected movement, and wherein the outer tube and the at least one tube leg includes a plurality of apertures configured to operatively couple the tube leg and base plate together; and
wherein the outer tube is selectively movable in relation to the inner leg to achieve a desired height level.

2. The modular tube apparatus of claim 1, wherein the base plate has at least one protrusion perpendicular to the base plate and includes a number of apertures configured to receive a fastening element.

3. The module tube apparatus of claim 1, wherein the base plate has at least one protrusion perpendicular to the base plate and includes a number of apertures configured to receive a fastening element.

4. The modular tube apparatus of claim 1, wherein the plurality of tube legs includes a number of apertures configured to receive a fastening element that is adapted to be selectively placed into to at least one outer aperture of the tube leg for adjusting the height of tube leg.

5. The modular tube apparatus of claim 1, wherein the plurality of tube legs includes a number of apertures configured to receive a fastening element that is adapted to be placed into to at least one aperture of the tube legs and adapted to secure a support frame.

6. A modular tube system comprising:
a plurality of outer tubes;
a tube leg, wherein the tube leg includes a male bracket and female bracket configured to couple together to form at least one composite inner leg; and
a base plate, the base plate being perpendicular to the axis of the plurality of tube legs and wherein the base plate has at least one protrusion perpendicular to the axis of the base plate and is adapted to support the plurality of tube legs in a vertical position.

7. The modular tube system of claim 6, wherein the base plate has at least one protrusion perpendicular to the base plate and includes a number of apertures configured to receive a fastening element.

8. The modular tube system of claim 6, wherein the plurality of tube legs includes a number of apertures configured to receive a fastening element that is adapted to be selectively placed into to at least one aperture of the plurality of tube legs for adjusting the height of the plurality of tube legs.

9. The modular tube system of claim 6, wherein the plurality of tube legs includes a number of apertures configured to receive a fastening element that is adapted to be placed into to at least one aperture of the tube legs and adapted to secure a support frame.
